(19) United States
(12) Patent Application Publication
(10) Pub. No.: US 2011/0143264 A1
(43) Pub. Date: Jun. 16, 2011

(54) STRUCTURE AND MANUFACTURING METHOD FOR FUEL CELL ELECTRODE

(76) Inventors: Ming-San LEE, Kaohsiung City (TW); Bo-Yu LIU, Kaohsiung City (TW); Long-Jeng CHEN, Kaohsiung City (TW)

(21) Appl. No.: 12/828,706

(22) Filed: Jul. 1, 2010

(30) Foreign Application Priority Data
Dec. 16, 2009 (TW) 098143196

(51) Int. Cl. H01M 4/02; H01M 4/88

(52) U.S. Cl. 429/523; 502/101

(57) ABSTRACT

A structure of fuel cell electrode comprises a diffusion layer having a surface, a conductive particle layer formed on the surface of the diffusion layer and a catalyst layer. The conductive particle layer has a plurality of conductive particles and a concavo-convex surface being composed of the conductive particles. The catalyst layer is formed on the concavo-convex surface of the conductive particle layer.

### FIELD OF THE INVENTION

The present invention is generally relating to a structure and manufacturing method of fuel cell electrode, more particularly to a structure and manufacturing method of fuel cell electrode that is capable of reducing catalyst amount and fabricating the electrode with large area.

### BACKGROUND OF THE INVENTION

A conventional fuel cell usually forms regular micro-pillar structures between a catalyst layer and a gas diffusion layer mainly means for increasing reaction area of the catalyst layer. The conventional fuel cell utilizes a method of nanoimprint lithography to fabricate micro-pillar structures. With reference to FIG. 1A-1D, the method of nanoimprint lithography applies a metal mold having micro-pillar structures so as to increase the interface area between the catalyst layer and the gas diffusion layer by mold pressing. However, the method of nanoimprint lithography is unable to apply in the fabrication of large area electrode. Besides, a carbon adhesion or a catalyst layer adhesion on the metal mold is likely occurred in the process of de-molding. Moreover, the metal mold being used in the method of nanoimprint lithography must fabricate with MEMS technology and follows the higher production cost.

### SUMMARY

A primary object of the present invention is to offer a structure and manufacturing method of fuel cell electrode, wherein the structure of fuel cell electrode comprises a diffusion layer having a surface, a conductive particle layer formed on the surface of the diffusion layer and a catalyst layer. The conductive particle layer has a plurality of conductive particles and a concavo-convex surface being composed of the conductive particles. The catalyst layer is formed on the concavo-convex surface of the conductive particle layer. The manufacturing method of fuel cell electrode comprises the steps of providing a diffusion layer having a surface; Forming a conductive particle layer on the surface of the diffusion layer, the conductive particle layer has a plurality of conductive particles and a concavo-convex surface being composed of the conductive particles; Forming a catalyst layer on the concavo-convex surface of the conductive particle layer. This invention is capable of fabricating fuel cell electrode with large area and low production cost, furthermore, the structure of fuel cell electrode in this invention has increased the area in contact with the catalyst layer via the concavo-convex surface of the conductive particle layer so as to reduce catalyst amount substantially.

### DESCRIPTION OF THE DRAWINGS

FIG. 1A-1D is a manufacturing flow illustrating a conventional fuel cell electrode in a method of nanoimprint lithography.

FIG. 2 is a manufacturing flow chart illustrating a fuel cell electrode in accordance with an embodiment of the present invention.

FIG. 3A-3C is a manufacturing flow illustrating the fuel cell electrode in accordance with an embodiment of the present invention.

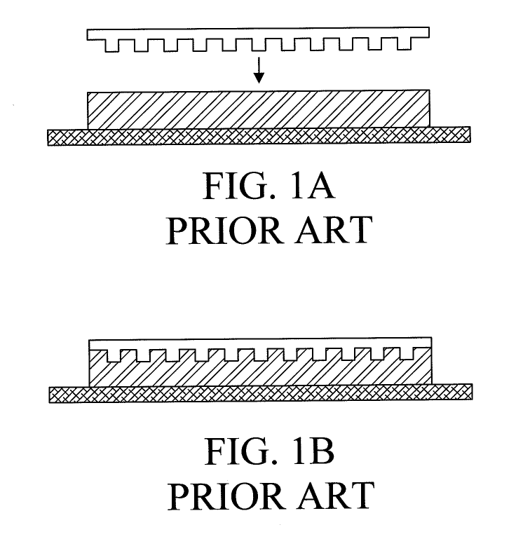

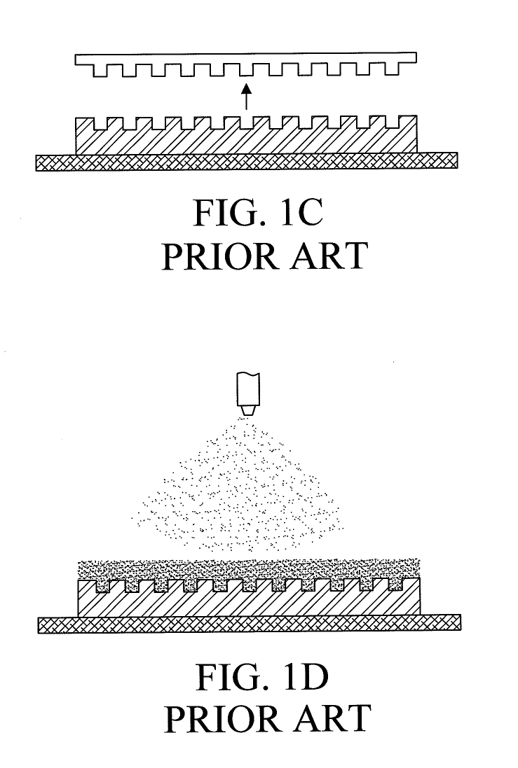

### DETAILED DESCRIPTION OF THE INVENTION

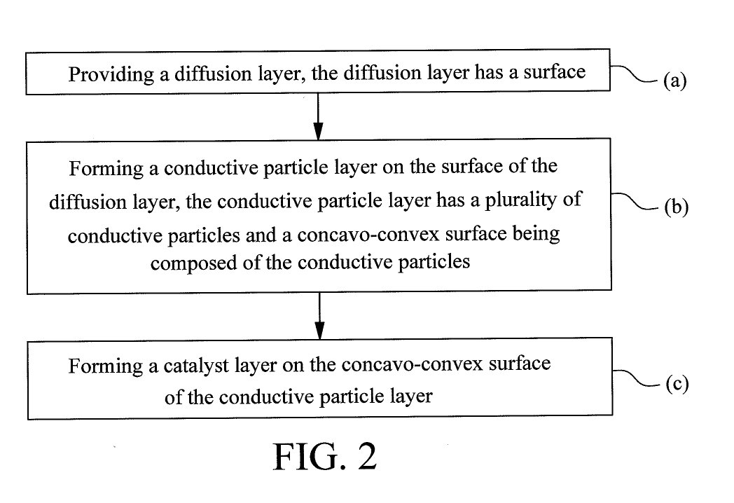

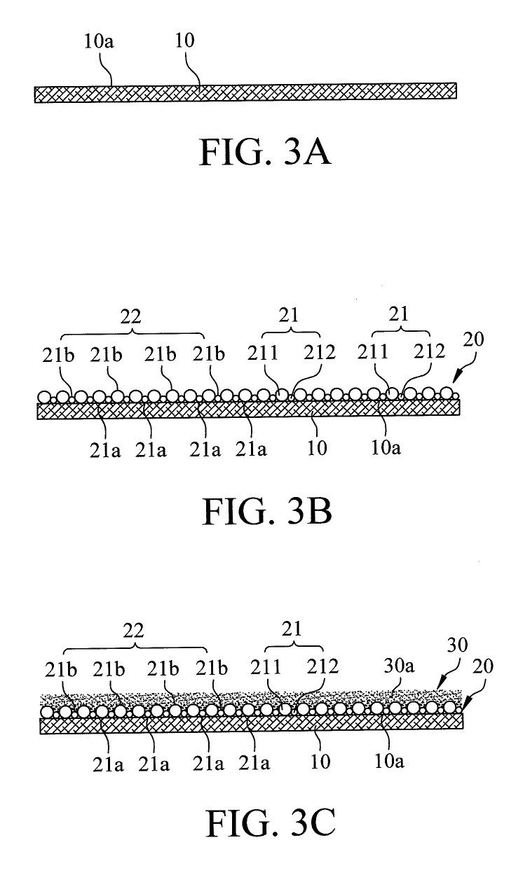

Referring to FIGS. 2 and 3A-3C, a manufacturing method of fuel cell electrode in accordance with an embodiment of this invention comprises the steps described as followed. First, referring to step (a) of FIGS. 2 and 3A, providing a diffusion layer 10 having a surface 10a, in this embodiment, the diffusion layer 10 is the gas diffusion layer. After that, referring to step (b) of FIGS. 2 and 3B, forming a conductive particle layer 20 on the surface 10a of the diffusion layer 10, wherein the conductive particle layer 20 has a plurality of conductive particles 21 and a concavo-convex surface 22 being composed of the conductive particles 21, in this embodiment, the conductive particles 21 of the conductive particle layer 20 are formed on the surface 10a of the diffusion layer 10 by spraying. Each of the conductive particles 21 has a first arc surface 21a in contact with the diffusion layer 10 and a second arc surface 21b opposite to the first arc surface 21a, wherein the concavo-convex surface 22 is composed of the second arc surfaces 21b of the conductive particles 21. Further in this embodiment, the conductive particles 21 at least include a plurality of first conductive particles 211 and a plurality of second conductive particles 212, preferably, the particle size of the first conductive particles 211 are greater than that of the second conductive particles 212 so as to enable the concavo-convex surface 22 to possess a more uneven surface (roughness) therefore increasing catalyst contact area. At last, referring to step (c) of FIGS. 2 and 3C, forming a catalyst layer 30 on the concavo-convex surface 22 of the conductive particle layer 20. The catalyst layer 30 is in contact with the second arc surfaces 21b of each of the conductive particles 21. In this embodiment, the catalyst layer 30 is composed of a plurality of catalyst particles 30a, preferably, the particle size of the catalyst particles 30a are smaller than that of the conductive particles 21 so as to enable the catalyst particles 30a to be adhered on the second arc surfaces 21b of the conductive particles 21. Further in this embodiment, the catalyst particles 30a are formed on the concavo-convex surface 22 of the conductive particle layer 20 by spraying. Or in another embodiment, the catalyst layer 30 is formed on the concavo-convex surface 22 of the conductive particle layer 20 by lamination.

The manufacturing method of this invention is capable of fabricating fuel cell electrode with large area and low production cost, furthermore, the structure of fuel cell electrode in this invention has increased the area in contact between the conductive particle layer 20 and the catalyst layer 30 via the concavo-convex surface 22 so as to reduce catalyst amount substantially.

Referring again to FIG. 3C, a structure of the fuel cell electrode according to the manufacturing method of this invention comprises a diffusion layer 10 having a surface 10a therein, a conductive particle layer 20 formed on the surface 10a of the diffusion layer 10 and a catalyst layer 30. The conductive particle layer 20 has a plurality of conductive particles 21 and a concavo-convex surface 22 being composed of the conductive particles 21. In this embodiment, each of the conductive particles 21 has a first arc surface 21a in contact with the diffusion layer 10 and a second arc surface 21b opposite to the first arc surface 21a, wherein the concavo-convex surface 22 is composed of the second arc surfaces 21b of the conductive particles 21. The conductive particles 21 at least include a plurality of first conductive particles 211 and a plurality of second conductive particles 212, preferably, the particle size of the first conductive particles 211 are greater than that of the second conductive particles 212 so as to enable the concavo-convex surface 22 to possess a more uneven surface (roughness) therefore increasing catalyst contact area. The catalyst layer 30 is formed on the concavo-convex surface 22 of the conductive particle layer 20 and the catalyst layer 30 is in contact with the second arc surface 21b of each of the conductive particles 21. In this embodiment, the catalyst layer 30 is composed of a plurality of catalyst particles 30a, preferably, the particle size of the catalyst particles 30a are smaller than that of the conductive particles 21 so as to enable the catalyst particles 30a to be adhered on the second arc surface 21b of the conductive particles 21.

While this invention has been particularly illustrated and described in detail with respect to the preferred embodiments thereof, it will be clearly understood by those skilled in the art that is not limited to the specific features shown and described and various modified and changed in form and details may be made without departing from the spirit and scope of this invention.

What is claimed is:

1. A structure of fuel cell electrode comprising:
A diffusion layer having a surface;
A conductive particle layer formed on the surface of the diffusion layer has a plurality of conductive particles and a concavo-convex surface being composed of the conductive particles; and
A catalyst layer formed on the concavo-convex surface of the conductive particle layer.

2. The structure of fuel cell electrode in accordance with claim 1, wherein each of the conductive particles has a first arc surface in contact with the diffusion layer and a second arc surface in contact with the catalyst layer, the concavo-convex surface is composed of the second arc surfaces of the conductive particles.

3. The structure of fuel cell electrode in accordance with claim 1, wherein the catalyst layer is composed of a plurality of catalyst particles, the particle size of the catalyst particles are smaller than that of the conductive particles.

4. The structure of fuel cell electrode in accordance with claim 1, wherein the conductive particles at least include a plurality of first conductive particles and a plurality of second conductive particles, the particle size of the first conductive particles are greater than that of the second conductive particles.

5. A manufacturing method of fuel cell electrode comprising the steps of:
(a) Providing a diffusion layer, the diffusion layer has a surface;
(b) Forming a conductive particle layer on the surface of the diffusion layer, the conductive particle layer has a plurality of conductive particles and a concavo-convex surface being composed of the conductive particles; and
(c) Forming a catalyst layer on the concavo-convex surface of the conductive particle layer.

6. A manufacturing method of electrode in accordance with claim 5, wherein each of the conductive particles has a first arc surface in contact with the diffusion layer and a second arc surface in contact with the catalyst layer, the concavo-convex surface is composed of the second arc surfaces of the conductive particles

7. A manufacturing method of electrode in accordance with claim 5, wherein the catalyst layer is composed of a plurality of catalyst particles, the particle size of the catalyst particles are smaller than that of the conductive particles.

8. A manufacturing method of electrode in accordance with claim 7, wherein the catalyst particles of the catalyst layer is formed on the concavo-convex surface of the conductive particle layer by spraying.

9. A manufacturing method of electrode in accordance with claim 5, wherein the conductive particles at least include a plurality of first conductive particles and a plurality of second conductive particles, the particle size of the first conductive particles are greater than that of the second conductive particles.

10. A manufacturing method of electrode in accordance with claim 5, wherein the conductive particles is formed on the surface of the diffusion layer by spraying.

11. A manufacturing method of electrode in accordance with claim 5, wherein the catalyst layer is formed on the concavo-convex surface of the conductive particle layer by lamination.
